(19) United States
(12) Patent Application Publication
(10) Pub. No.: US 2023/0099815 A1
(43) Pub. Date: Mar. 30, 2023

(54) FUEL CELLS WITH IMPROVED MEMBRANE LIFE

(71) Applicant: HYZON MOTORS INC., Honeoye Falls, NY (US)

(72) Inventors: Rajesh Bashyam, Delta (CA); Joselito Venturina, NEW WESTMINSTER (CA)

(21) Appl. No.: 17/956,368

(22) Filed: Sep. 29, 2022

Related U.S. Application Data
(60) Provisional application No. 63/249,812, filed on Sep. 29, 2021.

(51) Int. Cl. H01M 4/86; H01M 8/1004; H01M 4/90; H01M 4/92; H01M 4/88

(52) U.S. Cl. CPC H01M 4/8657; H01M 8/1004; H01M 4/9016; H01M 4/926; H01M 4/8652; H01M 4/881; H01M 4/8807; H01M 4/8814; H01M 2250/20; H01M 2004/8684

(57) ABSTRACT

A membrane electrode assembly can include an anode layer. The anode layer can include a first layer, and a second layer. The second layer can include a cerium oxide. A method of assembling a membrane electrode assembly can include provision of a membrane, a first layer, and a second layer. The second layer can include a cerium oxide. The first layer can be disposed on the second layer to form an anode layer. The anode layer can be disposed on an anode side of the membrane.

### CROSS-REFERENCE TO RELATED APPLICATIONS

This application claims the benefit of U.S. Provisional Application No. 63/249,812, filed on Sep. 29, 2021. The entire disclosure of the above application is incorporated herein by reference.

### FIELD

The present disclosure relates generally to fuel cells, and more particularly, to fuel cells having a membrane electrode assembly including a dual layer anode.

### INTRODUCTION

This section provides background information related to the present disclosure which is not necessarily prior art.

Traditionally, electricity is generated using fossil fuels. However, most scientists agree that emissions of pollutants and greenhouse gases from fossil fuel-based electricity generation account for a significant portion of world greenhouse gas emissions; in the United States, electricity generation accounts for nearly 40% of emissions, the largest of any source. Therefore, consumers and the general public are interested in other methods of producing electricity that can militate against the gas emissions generated by fossil fuel-based electricity generation. Several different methods of generating electricity have been proposed as possible substitutes, such as nuclear, geothermal, wind, tidal, and solar. Of the proposed technologies, fuel cells perhaps offer the most attractive solution for replacing fossil fuels.

A fuel cell combines fuel and air in an electrochemical reaction that produces both electricity and heat. Typically, a fuel cell is comprised of an electrolyte disposed between two electrodes (i.e., positive and negative terminals). The electrodes can have pores that allow fuel, air, and reaction products to flow with minimal resistance. The electrodes are good electrical conductors and can also act as catalysts to increase the rate of the electrochemical reaction within the fuel cell.

Fuel cells are typically classified according to the type of electrolyte employed. For example, proton exchange membrane fuel cells (PEMFC) typically use synthetic polymers as an electrolyte. A membrane electrode assembly (MEA) of a PEMFC cell assists in producing the electrochemical reaction needed to separate electrons. On the anode side of the MEA, a fuel (e.g., hydrogen) is dissociated by an anode catalyst to protons and electrons. The protons can diffuse through the membrane and be met on the cathode end by an oxidant (e.g., oxygen) which can bond with the fuel and can receive the electrons that were separated from the fuel. Catalysts on each side of the MEA facilitate the desired reactions and the membrane can allow protons to pass through while keeping the anode and cathode gases separate. In this way, cell potential is maintained, and current is drawn from the cell producing electricity.

The fuel cell can also include a porous gas diffusion layer and a microporous layer. The gas diffusion layer can provide electrical and thermal conductivity with chemical and corrosion resistance. The gas diffusion layer can also control the flow of reactant gases (hydrogen and air) and manage the water transport out of the MEA. The microporous layer can militate the contact resistance between the gas diffusion layer and the catalyst layer in the electrode. Also, the microporous layer can limit the loss of catalyst to the gas diffusion layer interior and can help improve water management.

Although fuel cells offer a promising alternative to fossil fuel-based generation, the application of fuel cell technology to create an optimized fuel cell has proven to be difficult. For example, improving the life of a membrane electrode assembly of a fuel cell is still an ongoing process and increasing lifespan without performance tradeoffs is highly desirable. Currently, cerium oxide has been used in the microporous layer and the gas diffusion layer, however, cerium can be unstable in certain applications. In addition, antioxidant has also been incorporated in the commercial membrane. Undesirably, these methods can permit cerium ions to negatively affect the performance of the MEA by occupying the proton sites on both cathode and the anode.

There is a continuing need for a membrane electrode assembly (MEA) for a fuel cell with an improved lifespan.

### SUMMARY

In concordance with the instant disclosure, a membrane electrode assembly (MEA) having an improved lifespan, has been surprisingly discovered.

The present technology can assist in releasing cerium at a slower rate. This can improve the lifespan of the MEA, while also mitigating against cerium ions from occupying proton sites on both a cathode side and an anode side of the fuel cell. In one embodiment, a membrane electrode assembly can include an anode layer. The anode layer can include a first layer, and a second layer. The second layer can include a cerium oxide. In another embodiment, a method of assembling a membrane electrode assembly can include provision of a membrane, a first layer, and a second layer. The second layer can include a cerium oxide. The first layer can be disposed on the second layer to form an anode layer. The anode layer can be disposed on an anode side of the membrane.

In certain embodiments, the anode side of the membrane electrode assembly can include a first layer and a second layer. The first layer can be disposed near the PEM. The first layer can be based on a platinum on carbon (Pt/C) catalyst with ionomer. Desirably, this can permit the first layer to function as a hydrogen oxidization layer. It should be appreciated that a skilled artisan can select different first layers, within the scope of this disclosure. The second layer can be disposed near the gas diffusion layer. The second layer can include a cerium oxide and CeO₂—NbO₂ composite with ionomer and with or without carbon. In certain embodiments, the composite oxide CeO₂-HbO₂ can also be surface modified fluorinated or non-fluorinated alkyl phosphonic acid before adding to the electrodes or coated on membrane. The oxides in the second layer can be annealed between 300° C. and 700° C. for 1 to 4 hours in air. Advantageously, this can permit the second layer to assist in radical scavenging and improving the lifespan of the PEM. In addition, it is believed without being bound to a particular theory, that the second layer can function as a secondary microporous layer. It should be appreciated that one skilled in the art can select different types of second layers, as desired. In addition, it should be appreciated that the first layer and the second layer be provided as a single layer.

In certain embodiments, at least one of the first layer, the second layer, and the single layer can be spray coated or slot die coated over a microporous layer on the gas diffusion layer. In more certain examples, the at least one of the first layer, the second layer, and the single layer can be coated over the microporous layer on the gas diffusion layer of the anode side.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 illustrates a schematic, exploded perspective view of a PEM fuel cell stack, showing only two fuel cells with a single bipolar plate assembly for purpose of simplicity, where each fuel cell includes a membrane electrode assembly, constructed in accordance with the present technology;

FIG. 2 is a schematic, exploded perspective view of a single fuel cell of the fuel cell stack of FIG. 1, showing the membrane and anode and cathode layers of the MEA, constructed in accordance with the present technology;

FIG. 3 is a schematic, partially exploded side cross-sectional view of the single fuel cell of FIG. 2, showing the membrane and anode layer including a first layer and a second layer of the MEA, constructed in accordance with the present technology; and

FIG. 4 is a flowchart illustrating a method of forming an MEA, in accordance with the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

A fuel cell can include bipolar plates, gaskets, and a membrane electrode assembly (MEA). Where the fuel cell is isolated or positioned at the end of a fuel cell stack, one or both the bipolar plates can be replaced by end plates. Fuel cells placed in between adjacent fuel cells in a fuel cell stack can be flanked by bipolar plates. As a non-limiting example, the fuel cell can be part of a fuel cell stack that can be used to provide electric power in a vehicle. However, it should be appreciated that a skilled artisan can employ fuel cells with various structures and applications, within the scope of this disclosure.

The bipolar plates are configured to surround the membrane electrode assembly and can be used to connect multiple membrane electrode assemblies of multiple fuel cells in series by stacking them relative to each other, thereby creating a fuel cell stack. This configuration can be employed to provide a desired output voltage. The bipolar plates can be manufactured from metal, carbon, or composites. Each of the bipolar plates can also include a flow field. The flow field can be a set of channels machined or stamped into the plates to permit fluid flow over the membrane electrode assembly. It should be appreciated that one skilled in the art can employ different bipolar plates, as desired.

Gaskets can be disposed between the bipolar plates and the membrane electrode assembly and can be configured to provide a fluid-tight seal to the membrane electrode assembly. The gaskets can be manufactured from an elastomer or polymer or any other material suitable for forming a gas-tight seal. In certain embodiments, the gasket can be formed of a sealant or can include a sealant. It should be appreciated that a skilled artisan can employ different gaskets, within the scope of this disclosure.

The MEA can include a membrane and electrode layers that include one or more catalysts. The electrode layers (e.g., anode layer and cathode layer) can include one or more identical or different catalysts. The membrane can include a proton exchange membrane (also referred to as a polymer electrolyte membrane), which can include one or more ionomers. The membrane can be configured to conduct protons therethrough while acting as an electric insulator and reactant fluid barrier; e.g., preventing passage of oxygen and hydrogen. It should be appreciated that one skilled in the art can select other types of membranes for the membrane, as desired. The membrane can be disposed between two catalyst layers, which can include various materials having one or more catalysts embedded therein. One of skill in the art can select other types of membranes, as desired, to be used in the MEA.

The membrane can be configured as an ion exchange resin membrane. Such ion exchange resins include ionic groups in their polymeric structure, one ionic component of which is fixed or retained by the polymeric matrix and at least one other ionic component is a mobile replaceable ion electrostatically associated with the fixed component. The ability of the mobile ion to be replaced under appropriate conditions with other ions imparts ion exchange characteristics to these materials.

The ion exchange resins can be prepared by polymerizing a mixture of ingredients, one of which contains an ionic constituent. One broad class of cation exchange, proton conductive resins is the so-called sulfonated polymer cation exchange resins. In the sulfonated polymer membranes, the cation ion exchange groups can include hydrated sulfonic acid radicals which are covalently attached to the polymer backbone.

Such ion exchange resins can be formed into membranes or sheets. Examples include sulfonated fluoropolymer electrolytes in which the membrane structure has ion exchange characteristics, and the polymer has a fluorinated backbone structure. Commercial examples of such sulfonated fluorinated, proton conductive membranes include membranes available from E.I. Dupont de Nemours & Co. under the trade designation NAFION. Another such sulfonated fluorinated ion exchange resin is sold by Dow Chemical.

A gas diffusion layer (GDL) can be disposed outside of each of the electrode layers (e.g., anode layer and cathode layer) and can facilitate transport of reactant fluids to the respective electrode layer, as well as facilitate removal of reaction products, such as water. Each of the gas diffusion layers can be compromised of a sheet of carbon paper in which the carbon fibers are partially coated with polytetrafluoroethylene (PTFE). Reactant fluids such as hydrogen gas and oxygen gas or air can diffuse through the pores in the gas diffusion layers. The gas diffusion layer can be coated with a thin layer of high-surface-area carbon mixed with PTFE, which can be referred to as a microporous layer. The microporous layer can be used to tailor a desired balance between water retention (as needed to maintain membrane conductivity) and water removal (as needed to keep pores open so hydrogen and oxygen can diffuse into the respective electrodes). It should be appreciated that a person skilled in the art can select other types of gas diffusion layers, within the scope of this disclosure. It should also be appreciated that the gas diffusion layers can be incorporated into the electrode layers.

The membrane can be disposed between at least two electrode layers including an anode layer and a cathode layer. The electrode layers can each include one or more types of catalysts, where certain embodiments can include particles of platinum (Pt) disposed on a high-surface-area carbon support (Pt/C). However, other noble group metals can also be used for the catalyst. The Pt/C can be mixed with an ion-conducting polymer (e.g., ionomer) and disposed between the membrane and the gas diffusion layers in forming the fuel cell. The supported platinum catalyst can be mixed with an ion-conducting polymer (ionomer) and disposed between the membrane and the gas diffusion layers. The anode catalyst layer enables hydrogen molecules to dissociate into protons and electrons. The cathode catalyst layer can enable oxygen reduction by reacting with the protons generated by the anode, producing water. The ionomer mixed into the catalyst layers allows the protons to travel through these layers.

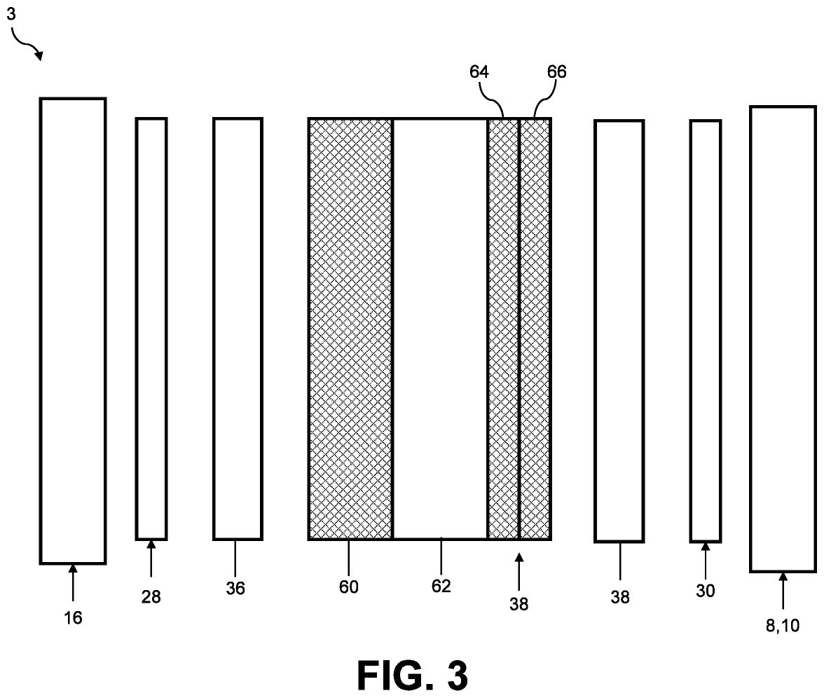

The microporous layer (shown in FIG. 3) can militate the contact resistance between the gas diffusion layer and the catalyst layer. The MPL may be formed of various materials, for example, carbon powder and a binder (e.g., PTFE particles). Also, the microporous layer can limit the loss of catalyst to the gas diffusion layer interior and can help improve water management. It should be appreciated that a person skilled in the art can select different microporous layers, as desired.

At the anode side of the membrane electrode assembly, a catalyst can cause the fuel to undergo oxidation reactions that generate ions (e.g., positively charged hydrogen ions or protons) and electrons. The ions move from the anode side to the cathode side through the electrolyte. At the same time, electrons flow from the anode side to the cathode side through an external circuit, producing direct current electricity. At the cathode side, another catalyst causes ions, electrons, and oxygen to react, which can form water or other byproducts.

The anode catalyst layer can include a first layer and a second layer. The first layer can be disposed adjacent to the polymer electrolyte membrane. The second layer can be disposed between the first layer and the gas diffusion layer. Though described herein as a single layer, it should be appreciated that the first layer and the second layer be combined into a single layer within the scope of the present disclosure.

The first layer can include a platinum on carbon (Pt/C) catalyst with an ionomer. Desirably, this can permit the first layer to function as a hydrogen oxidization layer. It should be appreciated that a skilled artisan can select different suitable material for the first layer, within the scope of this disclosure.

The second layer can include a composite material. The composite oxide material can be configured to assist in radical scavenging (e.g., a material that scavenges hydroxyl radicals and/or perhydroxyl radicals). It should be appreciated that by assisting in radical scavenging, the composite oxide material can improve the lifespan of the PEM.

The composite oxide material can be stabilized and surface functionalized. In particular, the composite oxide material can be stabilized via heat treatment. For example, the composite material can be annealed at a temperature between 300° C. and 700° C. for approximately one (1) hour to four (4) hours in air. It should be appreciated that an example process of surface functionalizing oxides is described in applicant's co-owned U.S. patent application Ser. No. 17/471,220 to Bashyam, the entire disclosure of which is incorporated herein by reference.

In particular, the composite material can be a composite of cerium oxide and CeO₂—NbO₂. The composite material can also include an ionomer. In addition to assisting in radical scavenging, it is believed without being bound to a particular theory, that the second layer can function as a secondary microporous layer. In certain embodiments, the composite oxide CeO₂—NbO₂ can also be surface modified fluorinated or non-fluorinated alkyl phosphonic acid before adding to the electrodes or coated on membrane. It should be appreciated that one skilled in the art can select different types of composite oxide material for the second layer, as desired.

The membrane electrode assembly (MEA) can be formed according to a method of the present disclosure. The method can generally include providing the PEM membrane, the first layer, and the second layer. In certain embodiments, the method can include the use of a decal transfer. The second layer can be applied to a film functioning as a backing layer or support layer, and the first layer can be applied onto the second layer to form a decal. The decal including the first layer and the second layer can then be transferred from the film to the membrane. In other embodiments, the first layer and the second layer can be applied as a single layer to the film. More particularly, the second layer can be integrated with the second layer to form the decal on the film, where the decal is then transferred to the membrane from the film. In a further embodiment, the second layer can be applied to the microporous layer of the gas diffusion layer. The second layer can be applied via spray coating or slot die coating, as non-limiting examples. The second layer can then be disposed on the first layer when the gas diffusion layer is disposed on the membrane. A skilled artisan can select other suitable means for preparing the MEA, within the scope of the present disclosure.

Advantageously, it is believed that first layer and the second layer can improve the lifespan of the membrane electrode assembly. In addition, it is believed without being bound to a particular theory, that the first layer and the second layer can militate against cerium ions from occupying proton sites on both the cathode side and the anode side of the fuel cell.

### Examples

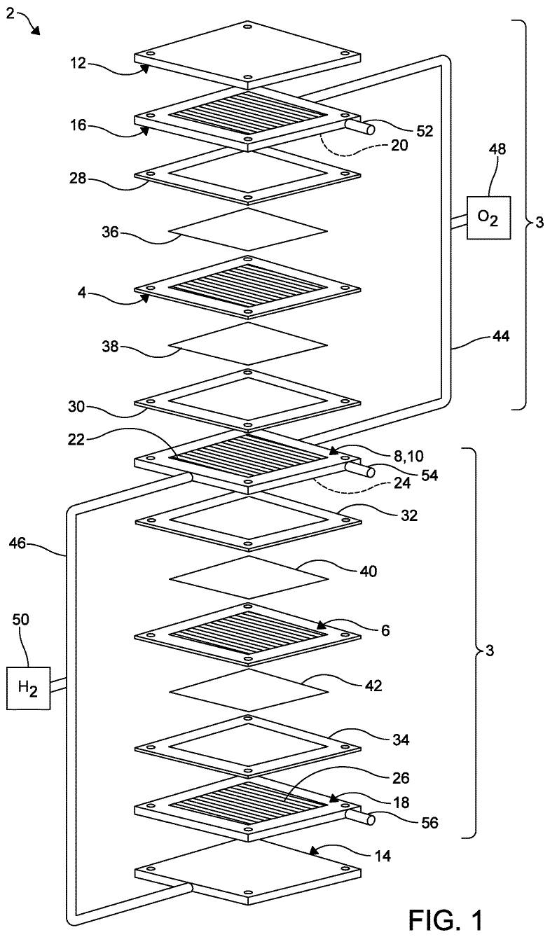

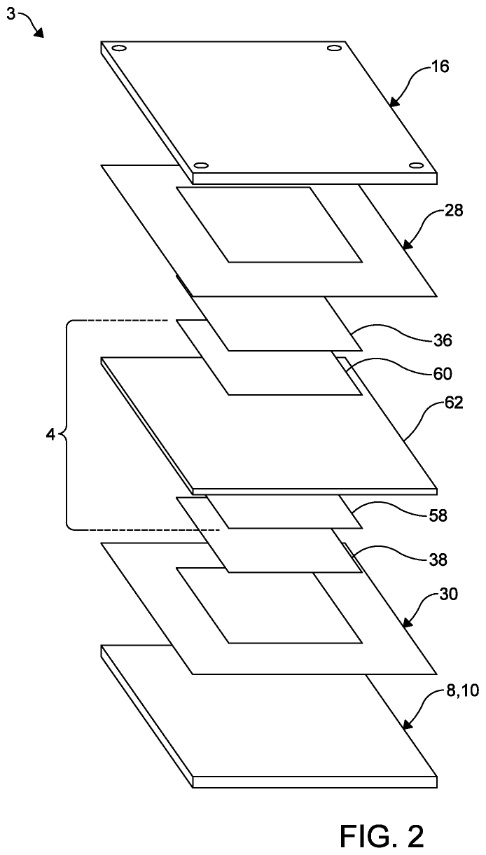

Example embodiments of the present technology are provided with reference to the several figures enclosed herewith. Non-limiting examples of fuel cells including embodiments of a membrane electrode assembly constructed in accordance with the present technology are shown in FIGS. 1-2. However, it should be appreciated that a skilled artisan can employ fuel cells with different structures, within the scope of this disclosure.

FIG. 1 depicts a PEM fuel cell stack 2 of two fuel cells 3, each fuel cell 3 having a membrane-electrode-assembly (MEA) 4, 6 separated from each other by an electrically conductive fluid distribution element 8, hereinafter also referred to as bipolar plate assembly 10. The MEAs 4, 6 each include a membrane-electrolyte layer having an anode layer and a cathode layer, each with catalyst, on opposite faces of the membrane-electrolyte layer. The MEAs 4, 6 and bipolar plate assembly 8, 10 are stacked together between end plates 12, 14 and end contact elements 16, 18 under compression. The end contact elements 16, 18 and the bipolar plate assembly 8, 10 include working faces 20, 22, 24, 26 respectively, for distributing fuel and oxidant gases (e.g., H₂ and air or O₂) to the MEAs 4, 6. Nonconductive gaskets 28, 30, 32, 34 provide seals and electrical insulation between the several components of the fuel cell stack 2.

Each of the MEAs 4, 6 are disposed between gas permeable conductive materials known as gas diffusion media 36, 38, 40, 42. The gas diffusion media 36, 38, 40, 42 can include carbon or graphite diffusion paper. The gas diffusion media 36, 38, 40, 42 can contact the MEAs 4, 6, with each of the anode layer and the cathode layer contacting an associated one of the gas diffusion media 36, 38, 40, 42. The end contact units 16, 18 contact the gas diffusion media 36, 42 respectively. The bipolar plate assembly 8, 10 contacts the gas diffusion media 38 on the anode face of MEA 4 (configured to accept hydrogen-bearing reactant) and also contacts gas diffusion medium 40 on the cathode face of MEA 6 (configured to accept oxygen-bearing reactant). Oxygen can be supplied to the cathode side of the fuel cell stack 2 from storage tank 48, for example, via an appropriate supply conduit 44. Hydrogen can be supplied to the anode side of the fuel cell from a storage tank 50, for example, via an appropriate supply conduit 46. Alternatively, ambient air can be supplied to the cathode side as an oxygen source and hydrogen to the anode from a methanol or gasoline reformer, and the like. Exhaust conduits (not shown) for both the anode and cathode sides of the MEAS 4, 6 are also provided. Additional conduits 52, 54, 56 are provided for supplying a coolant fluid to the bipolar plate assembly 8, 10 and the end contact elements 16, 18. Appropriate conduits for exhausting coolant from the bipolar plate assembly 8, 10 and end contact elements 16, 18 are also provided (not shown).

With reference now to FIG. 2, the MEA 4 of one of the fuel cells of the fuel cell stack 2 is shown in greater detail, where an anode layer 58 and a cathode layer 60 are separated by a membrane 62. The anode layer 58 enables hydrogen molecules to dissociate into protons and electrons and can include hydrogen bronzes 66 interspersed therein. The cathode catalyst layer 60 can enable oxygen reduction by reacting with the protons generated by the anode, producing water. Ionomer mixed into the catalyst layers 58, 60 allows the protons to travel through these layers. In certain embodiments, the anode layer 58 of the membrane electrode assembly 4 can include the first layer 64 and the second layer 66.

The first layer 64 can include a platinum on carbon (Pt/C) catalyst with an ionomer. The second layer 66 can include a composite material. The composite oxide material can be configured to assist in radical scavenging (e.g., a material that scavenges hydroxyl radicals and/or perhydroxyl radicals). It should be appreciated that by assisting in radical scavenging, the composite oxide material can improve the lifespan of the PEM. In particular, the composite material can be a composite of cerium oxide and CeO₂—NbO₂. The composite material can also include an ionomer. In addition to assisting in radical scavenging, it is believed without being bound to a particular theory, that the second layer can function as a secondary microporous layer. It should be appreciated that one skilled in the art can select different types of composite oxide material for the second layer, as desired.

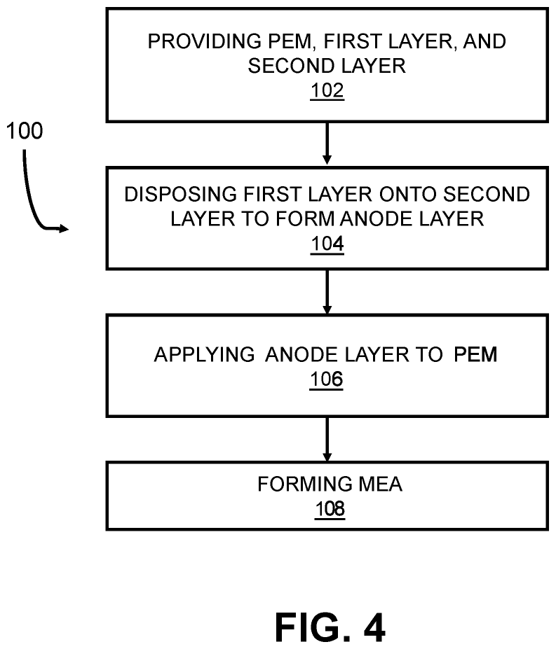

With reference to a method 100 of forming an MEA with the present technology, as shown in FIG. 4, the steps can include providing a first layer, a second layer and a PEM 102. Then, disposing the first layer on the second layer to form an anode layer 104, where the second layer includes a cerium oxide. The anode layer is then disposed on an anode side of a proton exchange membrane 106. In certain embodiments, disposing the first layer on the second layer to form the anode layer includes disposing the second layer on a film and disposing the first layer on the second layer to form a decal. Disposing the anode layer on the anode side of the proton exchange membrane can also include transferring the decal from the film to the anode side of the proton exchange membrane, thereby forming the MEA 108.

It should be appreciated that the present disclosure further includes a vehicle such as an automobile, truck, tractor, aircraft, watercraft or the like having a fuel cell with a membrane electrode assembly as described hereinabove.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A membrane electrode assembly, comprising:
an anode layer, the anode layer including:
a first layer, and
a second layer, including a cerium oxide.

2. The membrane electrode assembly of claim 1, further comprising:
a proton exchange membrane;
a gas diffusion layer; and
a cathode layer.

3. The membrane electrode assembly of claim 2, wherein the first layer is disposed adjacent to the proton exchange membrane.

4. The membrane electrode assembly of claim 3, wherein the second layer is disposed between the first layer and the gas diffusion layer.

5. The membrane electrode assembly of claim 1, further comprising a microporous layer.

6. The membrane electrode assembly of claim 1, wherein the first layer includes a platinum on carbon catalyst.

7. The membrane electrode assembly of claim 1, wherein the cerium oxide of the second layer includes a CeO₂—NbO₂ composite.

8. The membrane electrode assembly of claim 1, wherein the cerium oxide is capable of performing radical scavenging.

9. The membrane electrode assembly of claim 1, wherein the cerium oxide is heat treated.

10. The membrane electrode assembly of claim 1, wherein the cerium oxide is surface functionalized.

11. The membrane electrode assembly of claim 1, wherein the first layer includes a platinum on carbon catalyst, the cerium oxide of the second layer includes a CeO₂—NbO₂ composite, the first layer is disposed adjacent to the membrane, and the second layer is disposed between the first layer and a gas diffusion layer.

12. A fuel cell comprising a membrane electrode assembly according to claim 1.

13. A fuel stack comprising a fuel cell including a membrane electrode assembly according to claim 1.

14. A vehicle comprising a fuel cell including a membrane electrode assembly according to claim 1.

15. A method of assembling a membrane electrode assembly, comprising:
disposing a first layer on a second layer to form an anode layer, the second layer including a cerium oxide; and
disposing the anode layer on an anode side of a proton exchange membrane.

16. The method of claim 15, wherein:
disposing the first layer on the second layer to form the anode layer includes disposing the second layer on a film and disposing the first layer on the second layer to form a decal; and
disposing the anode layer on the anode side of the proton exchange membrane includes transferring the decal from the film to the anode side of the proton exchange membrane.

17. The method of claim 15, further comprising contacting the second layer with a gas diffusion layer.

18. The method of claim 15, wherein the first layer includes a platinum on carbon catalyst and the cerium oxide of the second layer includes a CeO₂—NbO₂ composite.

19. The method of claim 15, wherein the first layer is disposed adjacent to the proton exchange membrane and the second layer is disposed between the first layer and a gas diffusion layer.

20. The method of claim 15, wherein the first layer includes a platinum on carbon catalyst, the cerium oxide of the second side includes a CeO₂—NbO₂ composite, the first layer is disposed adjacent to the membrane, and the second layer is disposed between the first layer and a gas diffusion layer.
